(19) United States
(12) Patent Application Publication
(10) Pub. No.: US 2016/0059215 A1
(43) Pub. Date: Mar. 3, 2016

(54) MANGANESE OXIDES/GRAPHENE NANOCOMPOSITES, FILMS, MEMBRANES AND METHODS OF MAKING THE SAME

(71) Applicant: Fraunhofer USA, Inc., Plymouth, MI (US)

(72) Inventor: . ., (US)

(73) Assignee: Fraunhofer USA, Inc., Plymouth, MI (US)

(21) Appl. No.: 14/815,079

(22) Filed: Jul. 31, 2015

Related U.S. Application Data
(60) Provisional application No. 62/031,846, filed on Jul. 31, 2014.

(51) Int. Cl. B01J 23/34; B01J 35/06; B01J 20/28; B01J 21/18; B01J 20/20; B01J 20/06

(52) U.S. Cl. CPC B01J 23/34; B01J 20/20; B01J 20/06; B01J 20/28035; B01J 21/18; B01J 35/065

(57) ABSTRACT

Graphene/manganese oxide-based structures (e.g., nanocomposites, films and membranes) are described herein, as well as methods of making the same.

### RELATED APPLICATION

This application claims priority to U.S. Provisional Patent Application Ser. No. 62/031,846, filed Jul. 31, 2014 which is incorporated herein by reference in its entirety.

### BACKGROUND

1. Technical Field

The present disclosure relates to nanocomposites, films, membranes and methods of making the same.

2. Discussion of the Related Art

Nanocomposite materials due to their unique structures often exhibit interesting physical and chemical properties which are widely used in diverse fields. For example, nanocomposites are being made for potential applications including adsorptions, separations, molecule and gas sensing, ion-exchange, catalysis, electrodes and among others.

Manganese oxide octahedral molecular sieves (OMS) constitute a class of molecular sieves. These materials have one-dimensional tunnel structures, which are constructed by the type of aggregation (e.g., corner-sharing, edge-sharing, or face-sharing) of the double MnO₆ octahedral chains. The various oxidation states of manganese (e.g., Mn²⁺, Mn³⁺, and Mn⁴⁺) and different arrangements of MnO₆ octahedral chains contribute to the formation of a large variety of OMS structures. Traditional commercial applications of such molecular sieves are mainly in the form of granules or pellets, because they are difficult to be prepared as films or membranes owing to their brittleness and poor mechanical properties.

### SUMMARY OF INVENTION

Graphene/manganese oxide-based structures (e.g., nanocomposites, films and membranes) are described herein, as well as methods of making the same.

In one aspect, a nanocomposite is provided. The nanocomposite comprises at least one layer comprising graphene and including a surface and manganese oxide nanowires on the surface of the layer. An average length of the nanowires is greater than about 10 micrometers and an average diameter of the nanowires is between about 5 nanometers and about 100 nanometers.

In one aspect, a film is provided. The film comprises a nanocomposite on a surface of a substrate. The nanocomposite comprises at least one layer comprising graphene and including a surface and manganese oxide nanowires on the surface of the layer. An average length of the nanowires is greater than about 10 micrometers and an average diameter of the nanowires is between about 5 nanometers and about 100 nanometers.

In one aspect, a free standing membrane is provided. The membrane comprises layers comprising graphene self-assembled with manganese oxide nanowires. An average length of the nanowires is greater than about 10 micrometers and an average diameter of the nanowires is between about 5 nanometers and about 100 nanometers.

Other aspects, embodiments and features will be understood from the drawings and the following description.

### BRIEF DESCRIPTION OF THE DRAWINGS

FIG. 1 shows the powder X-ray diffraction pattern of a graphene/OMS-2 membrane produced according to methods described herein;

FIG. 2 shows the scanning electron micrograph of a graphene/OMS-2 membrane produced according to methods described herein;

FIG. 3 shows the scanning electron micrograph of a graphene/OMS-2 membrane produced according to methods described herein; and

FIG. 4 shows the transmission electron micrograph of a graphene/OMS-2 membrane produced according to methods described herein.

### DETAILED DESCRIPTION

Graphene/manganese oxide-based structures (e.g., nanocomposites, films and membranes) are described herein, as well as methods of making the same. The structures may include manganese oxide nanowires and at least one layer that comprises graphene. In some embodiments, the manganese oxide nanowires are octahedral molecular sieves (OMS). The potential applications of the graphene/manganese oxide-based structures include, but are not limited to, gas/liquid phase separation, catalysis, electrochemistry field and adsorption, sensors and environmental applications.

The manganese oxide nanowires may be distributed on a surface of the layer. In some embodiments, the nanowires are uniformly distributed. The nanowires may be well dispersed throughout the nanocomposite.

The manganese oxide nanowires may have an average diameter between about 5 nm and about 100 nm. In some embodiments, the average diameter may be between about 10 nm and 50 nm. The diameter of the nanowires in the composite may be relatively uniform.

The nanowires may be relatively long. For example, the average length of the nanowires may be greater than about 10 microns and, in some cases, greater than about 25 microns.

In some embodiments, the manganese oxide nanowires cross-connect. For example, the nanowires can cross-connect and extend to form films and membranes with any suitable size and any suitable shape.

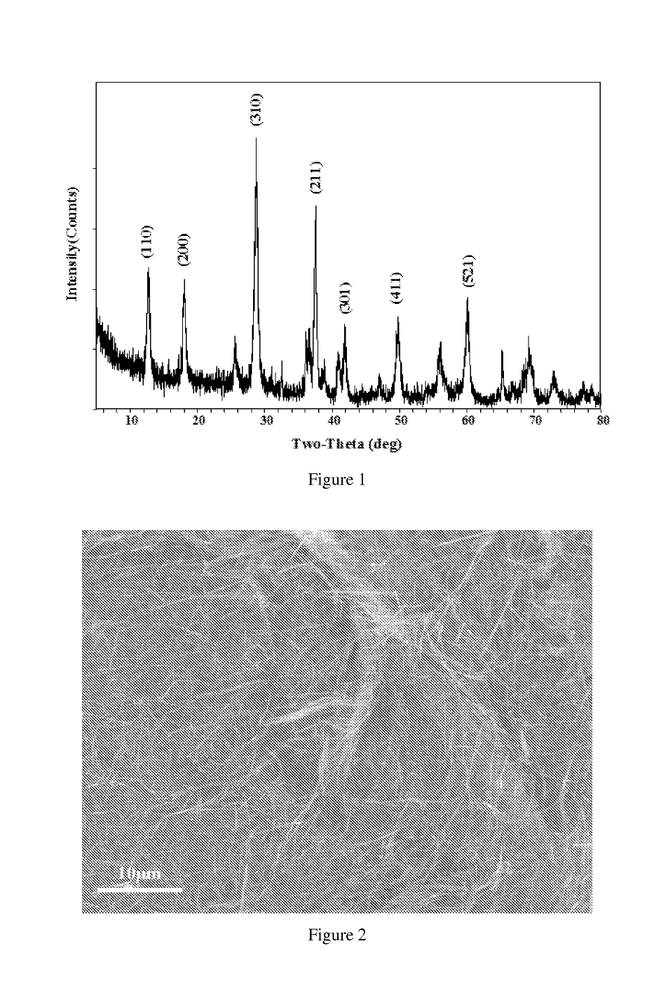

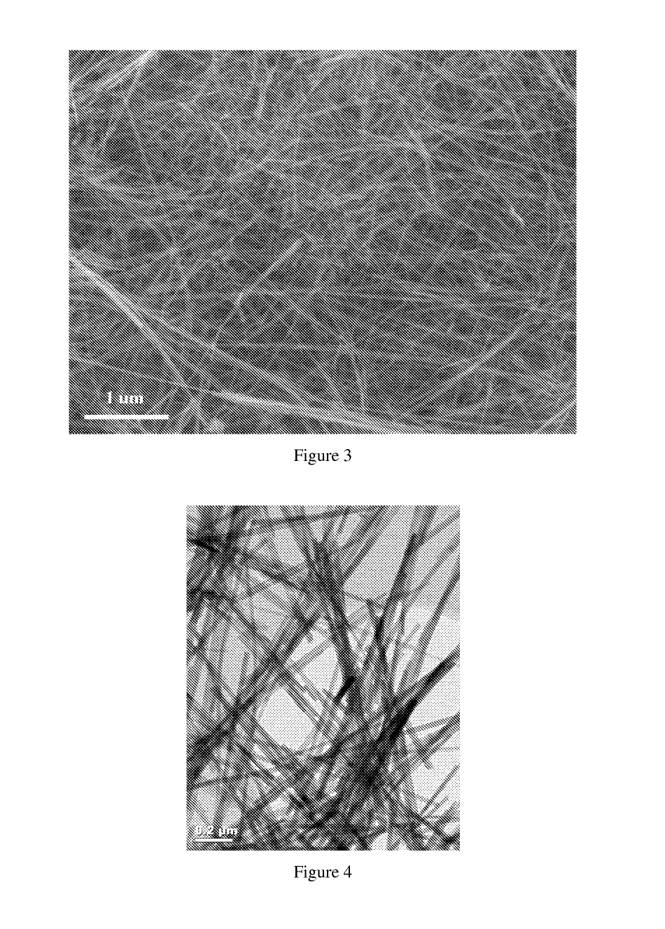

FIGS. 2-4 show representative images of the manganese oxide nanowires in the composites.

As noted above, the manganese oxide nanowires may be octahedral molecular sieves (OMS). In some embodiments, one or more cations may be introduced into the OMS structure. The cations can be alkali metal, alkaline earth metal, rare earth metal, transition group metal, and complex cation with various oxidation states from +1 to +4. For example, the manganese oxide octahedral molecular sieves may include an interstitial cation (e.g., in the tunnel of the sieve). Examples of suitable interstitial cations include those of H, Li, K, Rb, Cs, Ba, Mg, Ca, Pb, Co, Ni, Cu, Fe, V, Nb, Ta, Cr, Mo, Ag, W, Zr, Ti, Cd, Zn, Ln, ammonium, and combinations thereof. The cation source can be metal nitrate, metal acetate, metal chloride, metal sulfate, or metal organic complex compounds, as long as the anion of the source is inert for the reaction between the metal source and chemical precursor. In one embodiment, the cation source is potassium hydroxide and potassium permanganate. In some embodiments, a combination of more than one cation source may be used. The combination may contain more than one anion or more than one cation. In some embodiments, hydrates of at least one of the foregoing compounds may be used.

The framework of the manganese oxide-based octahedral molecular sieve may be substituted by other suitable cations. The cations exist in the framework of manganese oxide and replace part of the manganese cation. Due to the multiple oxidation state of manganese, the substitute cation may present in various oxidation states. Possible substitute cations include, but are not limited to, Fe, Co, Ni, V, W, Mo, Li, Ru, Na, Cs, Ba, Mg, Ca, Ti, Zr, Cd, Zn, Cu, and combinations thereof. These cations can be introduced by their corresponding salts like nitrate, sulfate, chloride, phosphate, persulfate, carbonate, dichromate, formate, chromate, and the like. In some embodiments, a combination of more than one of the above mentioned compounds may be used. More than one anions or different substitute cations may be used. In some embodiments, hydrates of the foregoing compounds containing the substitute cations may be used. The amount of the substituting cation should be enough to successfully introduce the cations to the framework but not too much to change the basic structure of the framework.

In some embodiments, the octahedral molecular sieve materials are birnessites. Birnessites include materials wherein the two-dimensional layered structure is formed of edge shared MnO₆ octahedra, with water molecules and/or metal cations occupying the interlayer region. The stoichiometry for birnessites is described as AₓMnO_{2-y}·zH₂O, wherein A represents for H⁺ or metal cations, x is about 0.2 to about 0.7, y is about -0.16 to about 0.16, and z is about 0.4 to about 0.8, the manganese in these materials is mixed-valent, with average oxidation states ranging from 3.6 to 3.8.

In some embodiments, the octahedral molecular sieve materials are hollandites. Hollandites include materials wherein the microporous structure is formed of tunneled, 2×2 arrays of edge-shared MnO₆ octahedra, with the average dimension size of these tunnels being about 4.6 Angstroms (Å). The interstitial cation such as Ba²⁺, Na⁺, Pb²⁺ and K⁺ may be present for maintaining overall charge neutrality. The stoichiometry for hollandites is described as A_{y}Mn₈O₁₆·xH₂O, wherein A represents for counter cations, x is about 6 to about 10, y is about 0.8 to about 1.5, the manganese in these materials is mixed-valent, with average oxidation states ranging from 3.68 to 3.96. Typical hollandites include hollandite (BaMn₈O₁₆), cryptomelane (KMn₈O₁₆), manjiroite (NaMn₈O₁₆), coronadite (PbMn₈O₁₆), and the like, and variants of at least one of the foregoing hollandites.

In some embodiments, the octahedral molecular sieve materials are cryptomelane type materials.

In some embodiments, the OMS materials made by the methods in the present disclosure are todorokites. Todorokites include materials wherein the microporous structure is formed of tunneled, 3×3 arrays of edge-shared MnO₆ octahedra, with the average dimension size of these tunnels is about 6.9 Å. An interstitial cation such as Ca²⁺, Mg²⁺, Ba²⁺, Na⁺, and K⁺ is present for maintaining overall charge neutrality. The stoichiometry for todorokites is described as A_{y}Mn₃O₇·xH₂O, wherein A represents for counter cations, x is about 3 to about 4.5, y is about 0.3 to about 0.5, the manganese in these materials is mixed-valent, with average oxidation states ranging from 3.4 to 3.8.

In some embodiments, the octahedral molecular sieve materials are romanechites. Romanechites include materials wherein the microporous structure is formed of tunneled, 2×3 arrays of edge-shared MnO₆ octahedra, containing a majority of Ba²⁺ and trace amounts of Na⁺, K⁺, and Sr²⁺ as tunnel cations.

In one embodiment, the OMS materials made by the methods in the present disclosure are pyrolusites. Pyrolusites include materials wherein the microporous structure is formed of tunneled, 1×1 arrays of edge-shared MnO₆ octahedra, with the average dimension size of these tunnels is about 2.3 Å. The tunnels are too small to be occupied by cations or small molecules.

In some embodiments, the octahedral molecular sieve materials are manganese oxides with 2×4 tunnel structures.

As noted above, the nanocomposites can include at least one layer comprising graphene. The nanocomposite may include a plurality of layers comprising graphene. In some embodiments, the layer(s) are made of graphene. In some embodiments, the layer(s) are made of graphene oxide. The layered structures of the graphene may help their future formation to film and then membrane.

The nanocomposites may be processed to form films and/or membranes. In some embodiments, films include the nanocomposite formed on a support. Membranes may be free standing. That is, a membrane may be formed by removing a support to leave a free-standing nanocomposite structure, as described further below.

In general films and/or membrane may have any suitable dimensions. For example, the surface area of the film may be about 10 to 600 square meters per gram. Typical membrane thicknesses may be between about 1 micrometer to 10 millimeter. The thickness of the prepared membrane may be tuned by the mass of the nanocomposite and the contacting area between the membrane and the support. It should be understood that other surface area and thicknesses may also be possible.

In some embodiments, the process described in this disclosure enables the successful synthesis of graphene/manganese oxide nanocomposites, films and membranes with unprecedented mechanical strength which are far less brittle and more stable than those prepared by methods of the prior art. The membranes obtained by embodiments of the process disclosed herein may be foldable and unbreakable after long time immersed in various solutions, including water, inorganic, organic, basic and acidic solutions.

Some embodiments described in the present disclosure enable one to prepare graphene or graphene oxide combined manganese oxide nanocomposites. The synergy effect between the two components may play an important role and may improve the physicochemical properties of the final product.

In some embodiments, methods of making the structures include the manganese oxide octahedral layer (OL) synthesis and graphene oxide (GO) prepared by a modified Hummers method. After combining GO with OL by a hydrothermal process, the as-obtained sample may be well dispersed giving a homogeneous nanocomposite suspension. A film generally may be formed by contacting the nanocomposite suspension with a support at a certain temperature and a membrane may be formed by removing the support from the film.

In one advantageous feature, embodiments of the method described in the present disclosure for making graphene/manganese oxide nanocomposites can be conducted under mild conditions, may require less preparation time and/or may eliminate the use of strong oxidants. This process may avoid a series of problems caused by strong oxidants like potassium permanganate. Strong oxidants leads to carbon loss, hinder the growth of OMS fibers and result in more structure defects in graphene. Those outcomes are unfavorable for nanocomposites preparation and their future growth to film and membrane.

In order to prepare the thin film, the prepared nanocomposites may, in some embodiments, be well dispersed to form a homogeneous suspension. The suspension solvent can be any of the inorganic or organic liquid, which is inert to the nanocomposite samples. Possible suspension solvent candidates include, but are not limited to, water, such as tap water, distilled water, DDW; acids, such as hydrochloric acid, nitric acid, sulfuric acid, phosphoric acid, acetic acid, oxalic acid; bases, such as sodium hydroxide, ammonia, barium hydroxide; alcohols, aldehydes and other organic solvents; and/or combinations including at least one of the above mentioned solvents. In one embodiment, DDW is chosen to be the suspension solvent. The suspension solvent may or may not be the same as the solvent used in the hydrothermal process.

The suspension formation can be facilitated by agitation. The form of agitation can be stirring, sonication, with or without external heating. In one embodiment, the suspension is formed by probe sonication. The resulted suspension may be homogeneous.

The film may be formed by self-assembly of the as-obtained nanocomposites on a support. The temperature and time for the self-assembly of the film may be lower and less than those made by process of the previous art. In some embodiments, the temperature is about 24-100° C. and the time of self-assembly is generally 1 to 10 hours.

The support may be any kind of solid material with a flat surface on which the film can self-assemble. Possible support includes, but is not limited to, glass, organic substrates, paper, wood, honeycomb, metals, alloys, ceramics, quartz, and the like. Suitable metals may include main group metals, transition metals, lanthanide metals, actinide metals, and the like. Suitable alloys may include steel, brass, pewter, amalgam, and the like. Possible polymers may include PTFE, FEP, and the like. In one embodiment, the support is ceramic.

The shape of the support is generally not limited. The support can be round, square, and/or any irregular shape. The film can be adopted according to the shape of the support.

The film may be freeze dried for about 12-24 hours. After drying a free-standing membrane (FSM) may be formed by removing the support from the film. The removal process may comprise peeling and cutting, or support dissolving.

This disclosure is further illustrated by the following non-limiting examples.

The samples made by some embodiments of the method described in this disclosure were characterized by several techniques. The phase of the products was analyzed by powder X-ray diffraction (PXRD) using a Rigaku Ultima IV diffractometer with Cu Kα radiation (λ=1.5406 [symbol] ) at room temperature. The operating voltage was 40 kV and the current was 40 mA. The diffraction patterns from 5°-75° were measured.

The morphologies of the samples were investigated with a Zeiss DSM 982 Gemini field emission scanning electron microscope (FE-SEM) with a Schottky emitter at an accelerating voltage of 2.0 kV and a beam current of 1.0 mA. Samples were dispersed in methanol and mounted on silicon wafers. High-resolution transmission electron microscopy (HR-TEM) images were collected by a JEOL 2010 FasTEM microscope operating at 200 kV. The samples were prepared by using a focused-ion-beam (FIB) technique to make them thin enough to be observed by HRTEM.

### EXAMPLE 1: Graphene/K-OMS-2

Typical GO synthesis from graphite flakes was carried out based on the modified Hummers method reported by Daniela et al. (Hummers, W. S., Offeman, R. E., Preparation of graphitic oxide. J. Am. Chem. Soc. 1958, 80, 1339.; Daniela C. Marcano, Dmitry V. Kosynkin, James M. Tour, et al. Improved synthesis of graphene oxide. ACS Nano, 2010, 4, 4806), the entire contents of which are incorporated herein by reference.

An exemplary manganese oxide OL synthesis was carried out based on the modified method reported by Qiuming et al. (Qiuming Gao, Oscar Giraldo, Wei Tong, and Steven L. Suib, Preparation of nanometer-sized manganese oxides by intercalation of organic ammonium ions in synthetic birnessite OL-1. Chem. Mater. 2001, 13, 778), the entire contents of which are incorporated herein by reference.

250 mg of as prepared K-OL-1 powder was dispersed in 50 ml deionized water by ultrasonic processing for 15 min, followed by adding 10 ml of GO into the suspension, stirring for another 15 min. The pH of the suspension was adjusted with ammonium hydroxide to about neutral. Afterward, the suspension was transferred into a 125 ml Teflon-lined stainless steel autoclave, sealed and maintained at 200° C. for 48 h to produce graphene/K-OMS-2 nanocomposites.

The as-obtained nanocomposites were suspended in 200 mL of DDW and stirred vigorously for a while, producing a homogeneous suspension. A self-assembly freestanding Graphene/K-OMS-2 film was made with vacuum filtration processing, as evidenced by the PXRD pattern of FIG. 1, and was then freeze drying for 24 hours.

### EXAMPLE 2: Graphene/Ni Doped K-OMS-2

A graphene/Ni doped K-OMS-2 nanocomposite was prepared according to Example 1, except the Ni(NO₃)₂·6H₂O was used for synthesis of nickel doped OL-1 material.

### EXAMPLE 3: Graphene/Fe Doped K-OMS-2

A graphene/Fe doped K-OMS-2 nanocomposite was prepared according to Example 1, except the Fe(NO₃)₃·9H₂O was used for synthesis of iron doped OL-1 material.

### EXAMPLE 4: Graphene/Co Doped K-OMS-2

A graphene/Co doped K-OMS-2 nanocomposite was prepared according to Example 1, except the Co(NO₃)₂·6H₂O was used for synthesis of cobalt doped OL-1 material.

### EXAMPLE 5: Graphene/NH₄-OMS-2

A graphene/NH₄-OMS-2 nanocomposite was synthesized according to Example 1, except the KOH was substituted with NH₄OH.

### EXAMPLE 6: Hydrothermal Ion Exchange of Graphene/NH₄-OMS-2

Graphene/NH₄-OMS-2 nanocomposites were synthesized according to Example 5. 5 batches of Graphene/NH₄-OMS-2 nanocomposites were mixed with LiOH, NaOH, KOH, RbOH, and CsOH respectively in DDW and placed in corresponding Teflon-lined autoclave. Each Teflon-lined autoclave was sealed and heat treated at 200° C. for 2 days to prepare Graphene/M-OMS-2 (M=Li, Na, K, Rb, Cs) nanocomposites, where the NH₄⁺ counter cation was replaced by Li⁺, Na⁺, K⁺, Rb⁺, and Cs⁺, respectively.

What is claimed is:

1. A nanocomposite comprising:
at least one layer comprising graphene; and
manganese oxide nanowires, wherein an average length of the nanowires is greater than about 10 micrometers and an average diameter of the nanowires is between about 5 nanometers and about 100 nanometers.

2. The nanocomposite of claim 1, wherein the manganese oxide nanowires are distributed on a surface of the layer.

3. The nanocomposite of claim 1, wherein the manganese oxide nanowires comprise manganese oxide-based octahedral molecular sieves.

4. The nanocomposite of claim 3, wherein the manganese oxide octahedral molecular sieves include an interstitial cation.

5. The nanocomposite of claim 4, wherein the interstitial cation comprises a cation selected from the group consisting of H, Li, K, Rb, Cs, Ba, Mg, Ca, Pb, Co, Ni, Cu, Fe, V, Nb, Ta, Cr, Mo, Ag, W, Zr, Ti, Cd, Zn, Ln, ammonium, and combinations thereof.

6. The nanocomposite of claim 3, wherein the manganese oxide octahedral molecular sieves include a framework substituting cation.

7. The nanocomposite of claim 6, where in the framework substituting cation comprises a cation selected from the group consisting of H, Li, K, Rb, Cs, Ba, Mg. Ca, Pb, Co, Ni, Cu, Fe, V, Nb, Ta, Cr, Mo, Ag, W, Zr, Ti, Cd, Zn, Ln, and combinations thereof.

8. The nanocomposite of claim 3, wherein the manganese oxide-based octahedral molecular sieves comprise a 1×n tunnel structure group comprising pyrolusite (with a 1×1 tunnel) and/or ramsdellite (1×2).

9. The nanocomposite of claim 3, wherein the manganese oxide-based octahedral molecular sieves comprise a 2×n tunnel structure group comprising hollandite (2×2) and/or romanechite (2×3).

10. The nanocomposite of claim 3, wherein the manganese oxide-based octahedral molecular sieves comprise a 3×n tunnel structure group comprising todorokite (3×3).

11. The nanocomposite of claim 1, wherein the nanocomposite comprises more than one layer comprising graphene.

12. The nanocomposite of claim 1, wherein the at least one layer is graphene.

13. The nanocomposite of claim 1, wherein the at least one layer is graphene oxide.

14. A film, comprising the nanocomposite of claim 1 on a surface of a support.

15. The film of claim 14, wherein the surface area of the film is about 10 to 600 square meters per gram.

16. A free standing membrane comprising:
layers comprising graphene self-assembled with manganese oxide nanowires, wherein an average length of the nanowires is greater than about 10 micrometers and an average diameter of the nanowires is between about 5 nanometers and about 100 nanometers

17. The membrane of claim 16, wherein the average thickness of the membrane is about 1.0 micrometer to 10 millimeters.
